(19) United States
(12) Patent Application Publication
(10) Pub. No.: US 2008/0020239 A1
(43) Pub. Date: Jan. 24, 2008

(54) Substrate For Magnetic Recording Medium, Magnetic Recording Medium, And Magnetic Recording And Reproducing Device

(75) Inventor: Hiroshi Osawa, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/628,363

(22) PCT Filed: Jun. 2, 2005
(86) PCT No.: PCT/JP05/10529

§ 371 Date: Mar. 6, 2007

(30) Foreign Application Priority Data
Jun. 4, 2004 (JP) 2004-166472

(51) Int. Cl. G11B 5/84; G11B 5/73

(52) U.S. Cl. 428/812; 216/22; 428/833; 428/846; 428/846.1

(57) ABSTRACT

A method for the production of a substrate for a magnetic recording medium includes subjecting a silicon substrate to a chemical etching treatment using an etchant containing an aqueous alkali solution and a surfactant. The substrate for a magnetic recording medium is provided on the surface thereof with irregularities possessing a value of contact ratio (BH 1.0 nm) of 5% or more and 20% or less in a region of a height of 1.0 nm or more, based on the height at which the contact ratio reaches 50% in the surface coarseness load curve. A magnetic recording medium can be provided using the substrate for a magnetic recording medium on which a magnetic film, a protective film and a lubricant layer are disposed. The magnetic recording medium is furnished on the surface thereof with irregularities having a value of contact ratio (BH 1.0 nm) of 5% or more and 20% or less in a region of a height of 1.0 nm or more, based on a height at which the contact ratio reaches 50% in a surface coarseness load curve. A magnetic recording and reproducing device can be provided using the magnetic recording medium and a magnetic head adapted to record and reproduce data in the magnetic recording medium.

### CROSS REFERENCE TO RELATED APPLICATIONS

This application is an application filed under 35 U.S.C. § 111(a) claiming the benefit pursuant to 35 U.S.C. § 119(e)(1) of the filing dates of Provisional Application No. 60/577,997 filed Jun. 9, 2004 and Japanese Patent Application No. 2004-166472 filed Jun. 4, 2004 pursuant to 35 U.S.C. § 111(b).

### TECHNICAL FIELD

This invention relates to a substrate for a magnetic recording medium to be used in a hard disk device, a method for the production of the substrate for a magnetic recording device, a magnetic recording device, and a magnetic recording and reproducing device. Particularly, this invention relates to a substrate for a magnetic recording medium using a silicon substrate of a small diameter exhibiting an excellent floating property and possessing a surface shape fit for the ramp loading operation and a method for the production of the substrate for the magnetic recording medium.

### BACKGROUND ART

Generally, the magnetic recording and reproducing device (magnetic disk device) is furnished with a magnetic recording medium (magnetic disk) disposed in a case, a spindle motor for supporting and driving the magnetic disk, and a head suspension assembly including a magnetic head adapted to read/write data for the magnetic disk.

The head suspension assembly is possessed of a slider shaping the magnetic head, a suspension supporting this slider, and an arm supporting this suspension. The head suspension assembly is rotatably supported by means of bearing assembly, and the magnetic head is moved to an arbitrary position on the magnetic disk by rotating the head suspension assembly with a voice coil motor.

In the magnetic disk device of this construction, the magnetic head is designed to fly with a fixed amount of floatation while the magnetic disk is rotating. That is, the magnetic head in the process of reading/writing is flying with a fixed amount of floatation on the magnetic disk and, as a result, the magnetic head and the magnet disk do not directly contact each other and do contribute to the enhancement of the reliability of the magnetic disk device.

In the magnetic disk device of this nature, for the purpose of reducing the change in the slider behavior which occurs during the accidental contact between the magnetic head and the magnetic disk, it is necessary that the surface roughness of the magnetic disk be increased more or less and that the adhering property of the slider to the magnetic disk be reduced.

Further, in recent years, the amount of floatation has been decreasing proportionately to the increase of the recording density and has fallen to the level of 10 nm to date. It is generally held that the suitability of the magnetic disk for low floatation increases in accordance as the specular surface thereof gains in fineness. Actually, however, the exaltation of the specular surface is unfit for the sake of low floatation because it inevitably induces the magnetic head to resonate. Also for the purpose of preventing the low floatation from inducing the magnetic head to resonate, it is necessary that the surface roughness of the magnetic disk be increased more or less.

The arithmetic mean coarseness Ra (described in Japanese Industrial Standard (JIS) B 0601) which has been heretofore used as the index of surface roughness results from integrally averaging the depths or heights from the center line of surface height to the concave parts or convex parts. The frictional force generated during the contact between the magnetic head and the magnetic disk is contributed greatly by the area of contact occupied by the convex parts and has only little relation with the concave parts. The Ra, therefore, does not serve as a satisfactory index for the surface roughness indicating the relation with the floating stability of the magnetic head.

As another index Rp which indicates the difference between the center line of surface height of the magnetic disk (media) and the largest height of the convex parts has been known. It, however, does not indicate the average height of the convex parts. Even when Rp is large, the frictional force during the contact is not reduced where the high convex parts are few. Thus, this index Rp and the floating stability are only slightly related.

In recent years, as an index for surface roughness, the difference between the height at which the contact ratio is 0.01% in the load curve, BH (0.01%), and the height at which the contact ratio is 50%, BH (50%), ΔBH [0.01, 50] (=|BH (0.01%)−BH (0.01%)|), has been adopted. A magnetic disk having this difference in the range of 3.0 nm or more to 6.0 nm or less has been proposed (refer, for example, to JP-A 2001-160214).

A substrate for a magnetic recording medium which has a height at which the contact ratio between the concave and convex parts of the surface is 0.4% fall in the range of 2.0 to 7.0 nm, based on the standard height at which the contact ratio between the concave and convex parts of the surface is 50%, has been proposed (refer, for example, to JP-A 2001-143246).

For the magnetic disk to be used in the magnetic disk device, the configuration having a metal film stacked by the sputtering technique on a substrate for a magnetic recording medium (the substrate for the magnetic disk) has been prevailing. As the substrates to be used for the magnetic recording media, aluminum substrates and glass substrates are widely used. The aluminum substrate is a product obtained by forming a Ni—P-based alloy film in a thickness of about 10 μm by the electroless plating technique on a substrate of Al—Mg alloy polished to a specular surface and polishing the produced film to a specular surface. The glass substrate is known in two kinds, i.e. amorphous glass and crystallized glass. Both of the glass substrates are finished in a specular surface prior to use.

The glass substrate has a high Young's modulus and a large shock resistance and as a result permits a decrease in thickness. It is, therefore, used for mobile commodities, such as note-sized personal computers, portable music players, and digital cameras.

Though the aluminum substrate has no high Young's modulus, it is pervious to electric current and is inexpensive and therefore finds utility for desktop personal computers.

Though the two kinds of substrates, namely glass substrates and aluminum substrates, are now being used for quantity production of commodities, silicon substrates and carbon substrates have been known.

Particularly, the silicon substrate has many advantages, such as the highness of Young's modulus, the ability to pass electric current and the obviation of the anxiety about the liquation of an alkali metal as experienced by the glass substrate.

To date, however, the silicon substrate has not been reduced to practice because of the unavailability of a technique for imparting proper coarseness to the surface thereof.

This invention has been initiated in the light of the true state of affairs described above. This invention is aimed at imparting proper surface roughness to a silicon substrate and consequently providing a substrate for a magnetic recording medium using a silicon substrate endowed with a surface shape exhibiting an excellent floating property and a method for the production of the substrate for a magnetic recording medium

The present inventors have continued a diligent study with the object of solving the problem mentioned above and as a result found that a chemical etching treatment performed with an etchant containing an aqueous alkali solution at a proper concentration and a surfactant at a proper concentration at a proper temperature is capable of forming proper irregularities to a surface. This invention has been perfected on this knowledge.

### DISCLOSURE OF THE INVENTION

A first aspect of the present invention provides a method for the production of a substrate for a magnetic recording medium, comprising subjecting a silicon substrate to a chemical etching treatment using an etchant containing an aqueous alkali solution and a surfactant.

In a second aspect of the invention including the first aspect, the chemical etching treatment imparts irregularities to a surface of the substrate.

In a third aspect of the invention including the first or second aspect, the aqueous alkali solution contains potassium hydroxide or sodium hydroxide and the etchant has a concentration of an alkali component in a range of 1 mass % to 60 mass %.

In a fourth aspect of the invention including any one of the first to third aspects, the surfactant is an anionic surfactant and the etchant has a concentration of an anionic surfactant component in a range of 0.1 mass % to 5 mass %.

In a fifth aspect of the invention including the fourth aspect, the anionic surfactant is at least one member selected from the group consisting of alkyl naphthalene sodium sulfonates, alkyl diphenyl ether sodium disulfonates and alkyl potassium phosphates.

In a sixth aspect of the invention including the fifth aspect, the surfactant is a cationic surfactant and the etchant has a concentration of a cationic surfactant component in a range of 0.1 mass % to 5 mass %.

In a seventh aspect of the invention including the sixth aspect, the cationic surfactant is at least one member selected from the group consisting of lauryl trimethyl ammonium chloride, stearyl trimethyl ammonium chloride and stearyl amine acetate.

In an eighth aspect of the invention including the seventh aspect, the surfactant is an amphoteric surfactant and the etchant has a concentration of an amphoteric surfactant component in a range of 0.1 mass % to 5 mass %.

In a ninth aspect of the invention including the eighth aspect, the amphoteric surfactant is at least one member selected from the group consisting of lauryl betaine, stearyl betaine and lauryl dimethyl amine oxide.

In a tenth aspect of the invention including any one of the first to ninth aspects, the etchant has a liquid temperature in a range of 20° C. to 80° C.

In an eleventh aspect of the invention including any one of the first to tenth aspects, the silicon substrate has surface irregularities having a value of contact ratio (BH 1.0 nm) of 5% or more and 20% or less in a region of a height of 1.0 nm or more, based on a height at which the contact ratio reaches 50% in a surface roughness load curve.

In a twelfth aspect of the invention including any one of the first to eleventh aspects, the silicon substrate is made of single crystal silicon.

In a thirteenth aspect of the invention including any one of the first to eleventh aspects, the silicon substrate is made of polycrystalline silicon.

In a fourteenth aspect of the invention including any one of the first to thirteenth aspects, the substrate has a diameter of 50 mm or less.

A fifteenth aspect of the invention provides a silicon substrate for a magnetic recording medium, which is provided on a surface thereof with irregularities possessing a value of contact ratio (BH 1.0 nm) of 5% or more and 20% or less in a region of a height of 1.0 nm or more, based on a height at which the contact ratio reaches 50% in a surface roughness load curve.

In a sixteenth aspect of the invention including the fifteenth aspect, the silicon substrate is made of single crystal silicon.

In a seventeenth aspect of the invention including the fifteenth aspect, the silicon substrate is made of polycrystalline silicon.

In an eighteenth aspect of the invention including any one of the fifteenth to seventeenth aspects, the substrate has a diameter of 50 mm or less.

A nineteenth aspect of the invention provides a substrate for a magnetic recording medium, produced using the method for the production of a substrate for a magnetic recording medium according to any one of the first to fourteenth aspects.

A twentieth aspect of the invention provides a magnetic recording medium furnished on the substrate for a magnetic recording medium according to any one of the fifteenth to nineteenth aspects with a magnetic film, a protective film and a lubricant layer, which medium is furnished on a surface thereof with irregularities having a value of contact ratio (BH 1.0 nm) of 5% or more and 20% or less in a region of a height of 1.0 nm or more, based on a height at which the contact ratio reaches 50% in a surface roughness load curve.

A twenty-first aspect of the invention provides a magnetic recording medium furnished on a substrate for magnetic recording medium using a silicon substrate with a magnetic film, a protective film and a lubricant layer, which medium is furnished on a surface thereof with irregularities having a value of contact ratio (BH 1.0 nm) of 5% or more and 20% or less in a region of a height of 1.0 nm or more, based on a height at which the contact ratio reaches 50% in a surface roughness load curve.

A twenty-second aspect of the invention provides a magnetic recording and reproducing device that is provided with the magnetic recording medium according to the twentieth or twenty-first aspect and a magnetic head adapted to record and reproduce data in the magnetic recording medium.

According to this invention, a substrate for a magnetic recording medium using a silicon substrate of a small diameter exhibiting an excellent floating property and possessing a surface shape fit for the ramp loading operation and a method for the production of the substrate for the magnetic recording medium are provided.

The above and other objects, characteristic features and advantages of the present invention will become apparent to those skilled in the art from the description given herein below with reference to the accompanying drawings.

### BRIEF DESCRIPTION OF THE DRAWINGS

FIG. 1 is a plan view illustrating an HDD for use in an embodiment of this invention.

FIG. 2 is a side view illustrating as magnified a magnetic head part in the HDD.

FIG. 3 is a cross-section of a magnetic disk for use in the embodiment of this invention.

FIG. 4 is a diagram for explaining the index of surface roughness of the magnetic disk.

FIG. 5 is a cross-section schematically illustrating a TD-TO testing device for the magnetic disk.

FIG. 6 is a diagram showing the relation between pressure in the TD-TO test and AE pressure.

FIG. 7 is a diagram showing the relation between the surface roughness of the magnetic disk and the TD pressure and TO pressure (in the absence of the texturing process).

FIG. 8 is a diagram showing the relation between the surface roughness of the magnetic disk and the Δ pressure (in the absence of the texturing process).

FIG. 9 is a diagram showing the relation between the surface roughness of the magnetic disk and the TD pressure and TO pressure (in the presence of the texturing process).

FIG. 10 is a diagram showing the relation between the surface roughness of the magnetic disk and the Δ pressure (in the presence of the texturing process).

### BEST MODE FOR CARRYING OUT THE INVENTION

Since the alkali etching of a silicon substrate proceeds in an anisotropic pattern, the (100) plane produces a difference in etching speed of about 100 times the etching speed of the (111) plane. In the applications to the semiconductors, the silicon substrate is held to be inferior in coarseness of the etched surface owing to the anisotropic etching. This invention forms necessary irregularities by making use of this characteristic property. Since the ratio of anisotropy is as large as 100, this property as it is does not permit precise control of the surface irregularities. Particularly, since the alkali etching treatment is not perfect in terms of homogeneity, it is helpless in incurring heavy dispersion of surface irregularities.

The addition of a surfactant, therefore, makes it possible to exalt the homogeneity and make precise control of surface irregularities. It is inferred that when the alkali etching is performed all by itself, the surface roughness grows in severity and the surface potential of a silicon substrate gains in inhomogeneity with the advance of etching. When the etching is implemented with the alkali solution containing the surfactant, however, the surface potential of a wafer is homogenized because the surfactant adheres to the wafer surface of a minus potential. As a result, the surface roughness is homogeneously controlled and is ideally finished eventually.

The control of the surface irregularities of a silicon substrate can be attained in a wide range by adjusting the concentrations of an alkali component and a surfactant in the etchant and the temperature and the duration of the etching treatment. The surface of a magnetic recording medium (magnetic disk) which is proper for low floatation requires the contact ratio (BH 1.0 nm) in a region of a height of 1.0 nm or more to be 5% or more and 20% or less, based on the height at which the contact ratio in the load curve of surface roughness is 50%. This invention contemplates imparting to a substrate for a magnetic recording medium or to a magnetic recording medium such surface roughness that the contact ratio (BH 1.0 nm) in a region of a height of 1.0 nm or more may be 5% or more and 20% or less.

As the silicon substrate which can be used in this invention, a single crystal silicon substrate proves favorable. By the experiment performed by the present inventors, it has been demonstrated that a polycrystalline silicon substrate obtains the same effect as the single crystal silicon substrate.

The substrate of this invention for a magnetic recording medium manifests the effect thereof conspicuously particularly when the diameter thereof is 50 mm or less and most preferably 25 mm or less. Practically, the lower limit of the diameter of the substrate is about 20 mm.

In recent years, for the purpose of enhancing the SNR of the electromagnetic transfer characteristic, the practice of performing a texturing process on a substrate for a magnetic recording medium (substrate for a magnetic disk), forming a magnetic film, for example, on this substrate and imparting magnetic anisotropy to the produced magnetic recording medium (magnetic device) has been in vogue. To be more specific, the texturing process causes the easily magnetizing axis of a Co alloy layer which is a magnetic layer to be oriented in the circumferential direction and enables the remanent magnetization and the squareness ratio in the circumferential direction to be heightened relative to the radial direction of the magnetic disk. Since the output of reproduction is enhanced substantially proportionately to the remanent magnetization, it is made possible to reduce the film thickness of the magnetic layer and improve the amplitude of transition of magnetization, the noise and the overwrite characteristic. That is, the textured medium which has undergone the texturing process (the magnetic recording medium endowed with anisotropy) shows signs of improvement in the resolution, half-width and the SNR and enjoys a great advantage as a medium of high recording density. Thus, the reduction of this textured medium to practice constitutes a powerful approach to the realization of highly densified recording.

This texturing process, however, results in shaving the convex parts (raised portions) of the surface of a magnetic disk substrate and therefore tends to reduce greatly the surface roughness of the magnetic disk substrate. As a result, the ability of the magnetic head to induce adhesion thereto of the magnetic disk is exalted. In order that the textured medium may win reliability, therefore, it is necessary that the surface roughness be rigidly controlled and optimized.

In the textured medium, the contact ratio (BH 1.0 nm) in a region of a height of 1.0 nm or more is properly 5% or more and 20% or less, and preferably 7% or more and 15% or less.

The textured medium has the easily magnetizing axis thereof oriented in the in-plane direction as surmised from the fact that the Co alloy layer has the easily magnetizing axis thereof oriented in the circumferential direction thereof. The medium of this sort is called “an in-plane medium.” The easily magnetizing axis of the Co alloy layer may be oriented in the direction vertical to the plane. The medium of this sort is called “a vertical medium.”

The conventional magnetic recording and reproducing device (magnetic disk device) has adopted the in-plane medium. In recent years, however, the characteristic properties of the vertical medium have been so enhanced as to promise the incorporation of the vertical medium in a magnetic disk device. The vertical medium does not need to undergo a texturing process because it obviates the necessity for orienting the easily magnetizing axis of the Co alloy layer in the circumferential direction. In the vertical medium of this sort which requires no texturing process, the contact ratio (BH 1.0 nm) in a region of a height of 1.0 nm or more must be 5% or more and 20% or less.

The magnetic disk device according to this embodiment of his invention is furnished with the magnetic disk mentioned above, a drive part for supporting and driving this magnetic disk, a magnetic head adapted to record and reproduce data for the magnetic disk and enabled to afford floatation in an amount of 10.0 nm or less to the magnetic disk and a head suspension assembly for supporting the magnetic head.

According to the magnetic disk described above and the magnetic disk device provided therewith, “BH 1.0 nm” is used as the index of the surface roughness of the magnetic disk. This “BH 1.0 nm” represents the value of contact ratio of a height of 1.0 nm or more, based on the height at which the contact ratio on the surface roughness load curve determined by an atomic force microscope (AF) is 50%.

This “BH 1.0 nm” has a great correlation with the stability of the amount of floatation in a region of low floatation. By controlling the surface roughness of a magnetic disk so as to set “BH 1.0 nm” at a level in the range of 5% to 20%, it is made possible to maintain the prepotency of the electromagnetic transfer characteristic of the magnetic disk and secure the stability of floatation even when the amount of floatation of the magnetic head is as small as 10.0 nm or less.

Now, this invention will be described in detail below with respect to the embodiment thereof, namely the application of a magnetic disk and a magnetic disk device provided therewith to a hard disk drive (hereinafter referred to as “HDD”), with reference to the drawings annexed hereto.

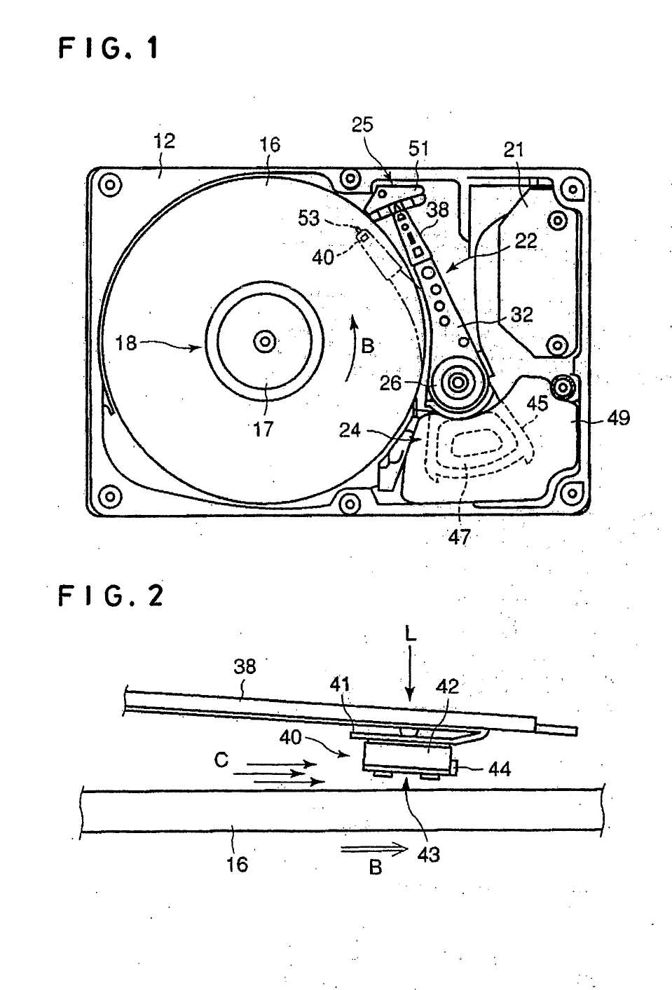

The HDD, as illustrated in FIG. 1, is furnished with a case 12 shaped like a rectangular box open on the upper side and a top cover (not shown) fastened with a plurality of screws to the case and adapted to close the upper opening of the case.

The case 12 holds therein two magnetic disks 16 (only one of them shown) as a magnetic recording medium, a spindle motor 18 as the drive part for supporting and rotating the magnetic disks, a plurality of magnetic heads serving to write and read data for the magnetic disks, a carriage assembly 22 supporting these magnetic heads freely movably relative to the magnetic disks 16, a voice coil motor (hereinafter referred to as “VCM”) 24 for rotating and positioning the carriage assembly, a ramp load mechanism 25 for retaining the magnetic heads at a place of refuge separated from the magnetic disks after the magnetic heads have moved to the outermost peripheries of the magnetic disks, and a substrate unit 21 furnished with a read-write amplifier, etc. constituting a processing circuit for a recording and reproducing signal.

To the low wall outer surface of the case 12, the spindle motor 18, the VCM 24 and a printed circuit board (not shown) for controlling the operation of the magnetic heads are screwed via the substrate unit 21.

Each of the magnetic disks 16 is provided on the upper side and the lower side thereof with magnetic recorders. The two magnetic disks 16 are fit into the outer periphery of a hub (not shown) of the spindle motor 18 and fixedly supported on the hub with a clamp spring 17 as well. As a result, the two magnetic disks 16 are coaxially disposed in a stacked state as opposed to each other across a stated gap. By driving the spindle motor 18, the two magnetic disks 16 are integrally rotated at a stated speed of 4200 rpm, for example, in the direction of the arrow mark B.

The carriage assembly 22 is provided with a bearing 26 fixed on the bottom wall of the case 12 and a plurality of arms 32 extending from the bearing. These arms 32 are laid in parallel to the surfaces of the magnetic disks 16 and are opposed to each other across a stated gap and extend, as well, from the bearing 26 in the same direction. The carriage assembly 22 is further provided with a suspension 38 of the shape of a resiliently deformable slender plate. The suspension 38 is formed of a leaf spring and has the basal terminal thereof fixed by spot welding or adhesion to the leading terminal of the arm 32 and extending from the arm. The suspensions 38 may be integrally formed with the corresponding arms 32. The arms 32 and the suspensions 38 jointly form a head suspension. The head suspension and the magnetic head jointly form a head suspension assembly.

Each of the magnetic heads 40, as illustrated in FIG. 2, is provided with a slider 42 of a substantially rectangular shape and a head part 44 formed on the terminal face of the slider and used for recording and reproducing data, and is fixed to a cymbal spring 41 disposed in the leading terminal part of the suspension. On each of the magnetic heads 40, the head load L directed toward the surface of the magnetic disk 16 is exerted by the resilience of the suspension 38. During the operation, the amount of floatation of the magnetic heads 40 relative to the magnetic disks 16 is set at a level of 10.0 nm or less.

The carriage assembly 22, as illustrated in FIG. 1, is provided with a supporting frame 45 extending from the bearing 26 in the direction opposite to the arm 32. By this supporting frame, a voice coil 47 forming part of the VCM 24 is supported. The supporting frame 45 is formed of synthetic resin integrally with the outer periphery of the voice coil 47. The voice coil 47 is interposed between a pair of yokes 49 fixed on the case 12 and enabled, in conjunction with these yokes and a magnet (not shown) fixed on one of the yokes, to form the VCM 24. Then, by energizing the voice coil 47, the carriage assembly 22 is rotated round the bearing 26 and the magnetic heads 40 are moved and positioned on a prescribed track of the magnetic disk 16.

The ramp load mechanism 25 is provided with ramps 51 provided on the bottom wall of the case 12 and disposed as well on the outer sides of the magnetic disks 16 and tabs 53 extending from the leading terminals of the suspensions 38. While the carriage assembly 22 is rotating toward the position of refuge outside the magnetic disk 16, the tabs 53 are engaged to the ramp faces formed in the ramps 51, subsequently pulled up by the inclinations of the ramp faces and enabled to unload the magnetic heads.

Now, the magnetic disks 16 in the HDD will be described in detail below.

The magnetic disk 16, as illustrated in FIG. 3, is provided with a substrate 50, i.e. a silicon substrate measuring 0.38 mm in thickness and 10 inches (25.4 mm) in outside diameter. The surface of the substrate 50 has undergone a chemical etching treatment using an etchant containing an aqueous alkali solution and a surfactant. In the case of an in-plane medium, the surface of the substrate 50 is preferred to have further undergone a texturing process from the viewpoint of the electromagnetic transfer characteristic. As regards the position of the texturing process in the sequence of component operations, the order of the chemical etching treatment and the texturing process and the order of the texturing process and the chemical etching treatment are both acceptable.

For the aqueous alkali solution to be contained in the etchant, potassium hydroxide and sodium hydroxide are usable. The concentration of the alkali component in the etchant mentioned above is in the range of 1 to 60 mass %. If the concentration of the alkali component falls short of 1 mass %, the shortage will result in preventing the etching effect from being fully manifested and the silicon surface from being coarsened. Conversely, if this concentration exceeds 60 mass %, the overage will result in suffering the etching effect to proceed unduly strongly and preventing the silicon surface from being coarsened with satisfactory controllability.

As the surfactant to be contained in the etchant, any of anionic surfactants, cationic surfactants and amphoteric surfactants may be used.

As the anionic surfactant, alkyl naphthalene sodium sulfonate, alkyl diphenyl ether sodium disulfonate or alkyl potassium phosphate is used. The concentration of the anionic surfactant component in the etchant mentioned above is in the range of 0.1 to 5 mass %. If the concentration of the anionic surfactant component falls short of 0.1 mass %, the shortage will result in preventing the surface potential of a wafer from being homogenized and the silicon surface from being coarsened homogenously. Conversely, if this concentration exceeds 5 mass %, the overage will result in rendering it difficult to clean and remove the anionic surfactant at a subsequent step.

As the cationic surfactant, lauryl trimethyl ammonium chloride, stearyl trimethyl ammonium chloride or stearyl amine acetate is used. The concentration of the cationic surfactant component in the etchant mentioned above is in the range of 0.1 to 5 mass %. If the concentration of the cationic surfactant component falls short of 0.1 mass %, the shortage will result in preventing the surface potential of a wafer from being homogenized and the silicon surface from being coarsened homogenously. Conversely, if this concentration exceeds 5 mass %, the overage will result in rendering it difficult to wash and remove the cationic surfactant at a subsequent step.

As the amphoteric surfactant, lauryl betaine, stearyl betaine or lauryl dimethyl amine oxide is used. The concentration of the amphoteric surfactant component in the etchant mentioned above is in the range of 0.1 to 5 mass %. If the concentration of the amphoteric surfactant component falls short of 0.1 mass %, the shortage will result in preventing the surface potential of a wafer from being homogenized and the silicon surface from being coarsened homogenously. Conversely, if this concentration exceeds 5 mass %, the overage will result in rendering it difficult to clean and remove the amphoteric surfactant at a subsequent step.

The etchant mentioned above is put to use at a liquid temperature in the range of 20 to 80° C. If the temperature falls short of 20° C., the shortage will result in suffering the etching treatment to proceed so slowly and fail to satisfy the expected productivity. Conversely, if the temperature exceeds 80° C., the overage will result in suffering the etching treatment to proceed very rapidly and the surface roughness to be excessively exalted.

On each of the surfaces of the substrate 50, a multilayer film is formed by sputtering. To be specific, on each of the surfaces of the substrate 50, an orientation adjusting film 52 made of a CoW alloy and having a thickness of 10 nm, a base film 54 made of a Cr-based alloy and having a thickness of 10 nm, a stabilizing layer 56 made of a CoCrZr alloy and having a thickness of 2 nm, a bonding layer 58 made of Ru and having a thickness of 1 nm, a magnetic layer 60 made of a CoCrPtB alloy and having a thickness of 15 nm, and a protective film 62 made of carbon and having a thickness of 3 nm are formed sequentially in the order mentioned. Further, on the protective film 62, a lubricant having perfluoropolyether as a main component is spread to form a lubricant film 64 having a thickness of 2 nm.

In the substrate for a magnetic disk or the magnetic disk 16, the individual surfaces thereof have their roughness formed in respectively prescribed ranges fixed as novel indexes. Specifically, the roughness of the individual surfaces are so formed that the values of contact ratio (BH 1.0 nm) in a region of a height of 10 nm or more may fall in the range of 5% or more and 20% or less, based on the height at which the contact ratio on the surface roughness load curve determined with an atomic force microscope (AFM) is 50%. The individual surfaces of the magnetic disk 16, as illustrated in FIG. 4, have the cross-sectional areas of the disk surface irregularities in the sections parallel to the surfaces of the magnetic disk 16 fall in the range of 5% to 20% of the areas in the range of determination (10 μm×10 μm) at a position of a height of 1.0 nm or more from the center line taken at a position at which the height of the section is 50% of that of the whole magnetic disk.

The convexes of the surface of the magnetic disk which measure about 3.0 nm in height are low. These convexes, during the contact with the magnetic head, are depressed by a size of some nm. Thus, the indexes mentioned above have been substantially determined on the basis of the theory that the ability of a magnetic disk to induce adhesion of the slider of a magnetic head is governed by the contact surface area produced between the slider and the magnetic disk surface when the convexes are depressed to a height of about 1.0 nm.

### EXAMPLES

A Si substrate measuring 25.4 mm in outside diameter, 7.0 mm in inside diameter and 0.38 mm in plate thickness was used. This Si substrate was a single crystal whose surface had a crystal orientation of (111). The Si substrate was polished to a specular finish Ra of 2.3 Å. The samples were subjected to an etching treatment, washed with a cleaning fluid having aqueous ammonia and aqueous hydrochloric acid as main components and subsequently dried. Tables 1 and 2 below show the alkali component and the surfactant component contained in the etchant, their concentrations, the etching temperature and the etching time. Table 2 shows the data obtained of the samples which were subjected to an etching treatment, dried and given a texturing process. The conditions for the texturing process were as shown below. The abrasive grains contained in the slurry were diamond abrasive grains having a D90 of 0.15 μm. The slurry was added dropwise at a rate of 50 ml/min. over a period of two seconds prior to the start of the process. As the polishing tape, a woven fabric of polyester was used. The polishing tape was fed at a rate of 75 mm/min. The rotational frequency of the disk was set at 600 rpm. The disk was shaken at a rate of 120 swings/min. The depressing force exerted on the tape was set at 2.0 kgf (19.6 N). The processing time was set at 10 seconds.

The surface shape of the magnetic disk was determined (Ra, BH 1.0 nm) with an atomic force microscope, with the range of determination set at 10 μm×10 μm and the number of scan lines at 256. The data resulting from the determination were subjected to a filter processing plain-fit (order=1 in both X and Y) and a flat-on (order=0) before they were used for the computation of a load curve.

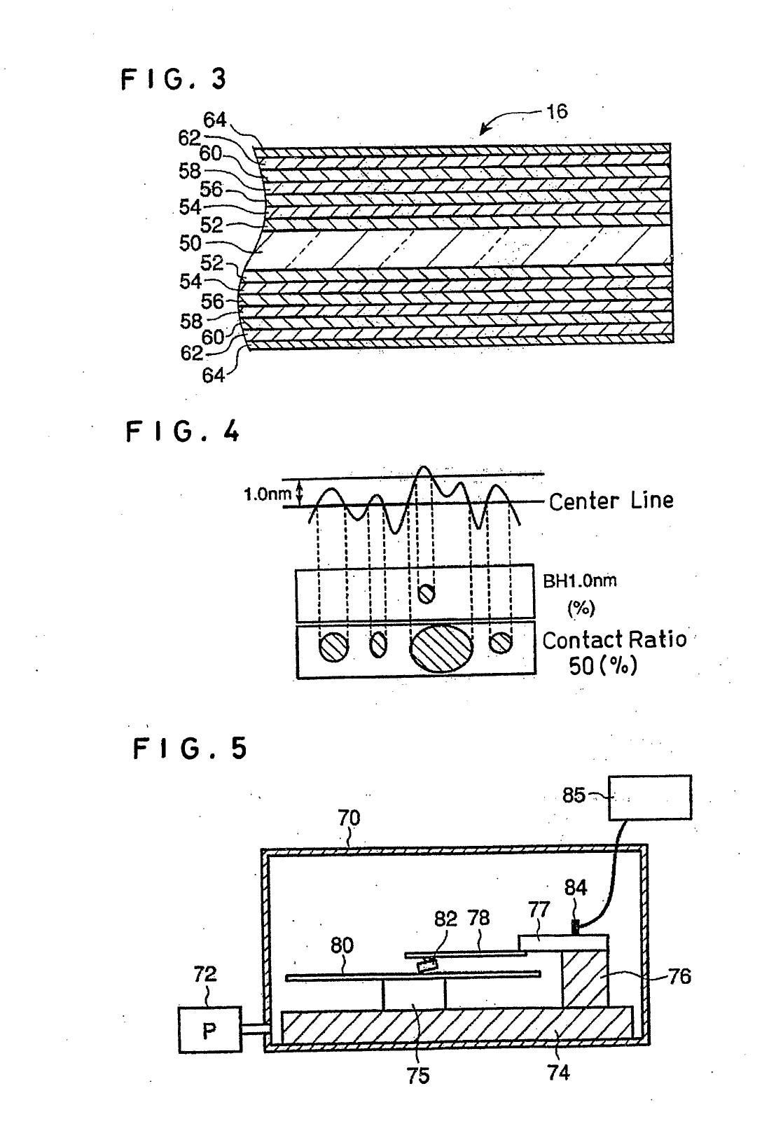

The samples were subjected to the TD-TO test with the object of rating the ability of the magnetic disk to induce adhesion. The test device used for the TD-TO test was furnished with a chamber 70 as illustrated in FIG. 5. The chamber 70 had connected thereto a vacuum pump 72 that could lower the pressure inside the chamber to about 0.3 atm. The chamber 70 had a stage 74 disposed therein and this stage was provided thereon with a spindle motor 75 and a supporting post 76. A magnetic disk 80 as a sample was supported by the spindle motor 75 and rotated at 4200 rpm, for example. The supporting post 76 had an arm 77 and a suspension 78 attached thereto. A magnetic head 82 for the test was supported at the leading terminal of the suspension. The arm 77 was provided with an acoustic emission (AE) sensor 84 for detecting the degree of contact between the magnetic head 82 and the magnetic disk 80. The AE sensor was connected to an oscilloscope 85.

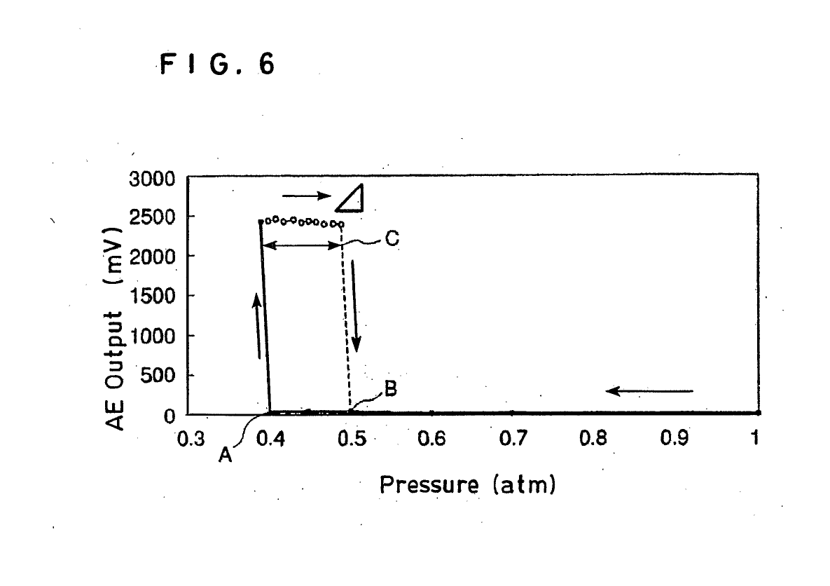

In the TD-TO test, the magnetic disk 80 was mounted on the spindle motor 75 and rotated at 4200 rpm. In the ensuing state of the testing device, the pressure inside the chamber 70 was gradually reduced and the amount of floatation of the magnetic head 82 relative to the magnetic disk was lowered. In this while, the output of the AE sensor 84 was monitored with the oscilloscope 85. The output of the AE sensor suddenly increased when the interior of the chamber reached a certain pressure as illustrated in FIG. 6. This fact indicates that the magnetic head contacted the surface of the magnetic disk. The pressure detected at this time was used as the touchdown (TD) pressure A.

When the pressure inside the chamber 70 was subsequently increased conversely, the AE output remained intact at the increased magnitude for a while. When the pressure reached a certain level, the noise level suddenly fell. This fact indicates that the magnetic head again floated from the magnetic disk surface. The pressure detected at this time was used as the takeoff (TO) pressure B. The difference between the TO pressure B and the TD pressure A (B-A) was reported as the Δ pressure C. The test for determining the TD pressure A, the TO pressure B and the Δ pressure C is referred to as the TO-TD test.

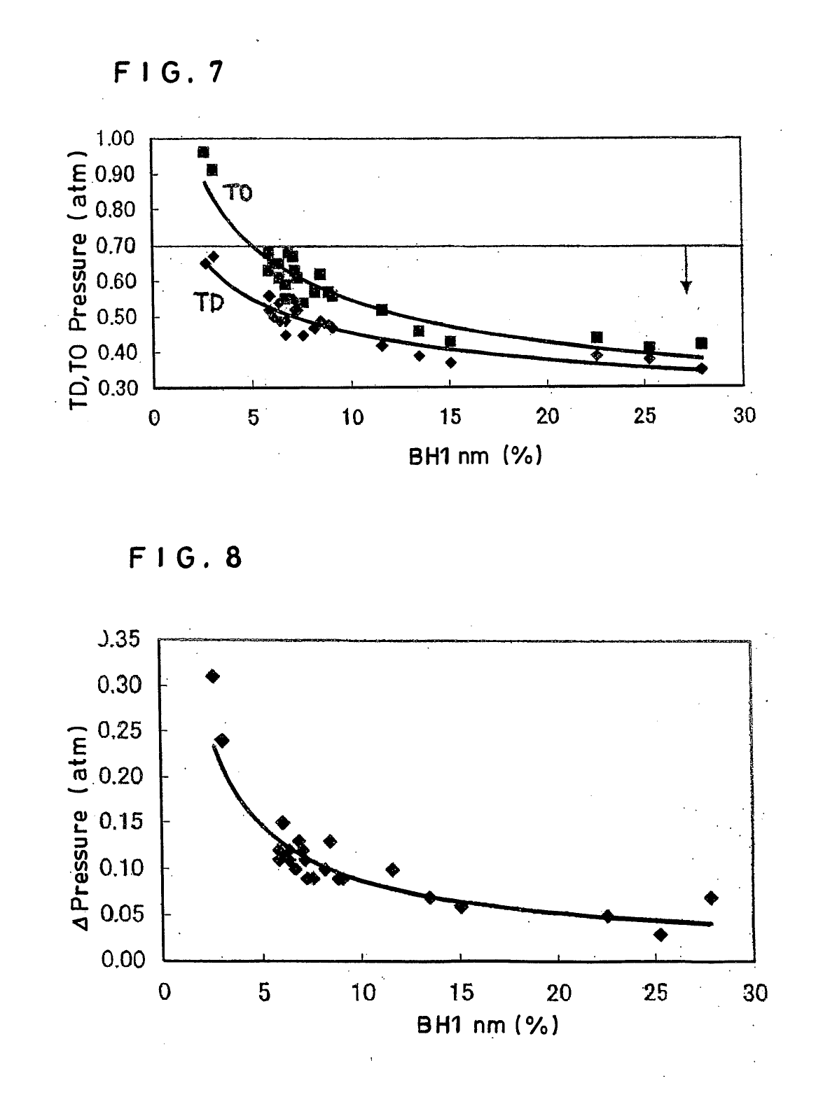

It is noted from FIG. 7, in the absence of the texturing process, it is necessary that “BH 1.0 nm” be 5% or more in order that the TO pressure inclusive of possible dispersion of data may be 0.7 atm. or less. When the “BH 1.0 nm” is smaller than 5%, the TD pressure does not decrease in spite of a decrease in the surface roughness of the magnetic disk. As is clear from FIG. 8, the Δ pressure C is suddenly increased, namely the ability to induce adhesion is increased. As a result, the phenomenon that the magnetic head fails to float from the surface of the magnetic disk even at 0.7 atm. takes place. Thus, when the “BH 1.0 nm” is smaller than 5%, the surface of the magnetic disk is flattened unduly and as a result the ability to induce adhesion is exalted and the frictional force generated during the contact with the magnetic head is sharply increased. The possibility that the magnetic head will vibrate, the recording and reproducing will be deprived of stability, or even the magnetic head and the magnetic disk will eventually fracture may ensue.

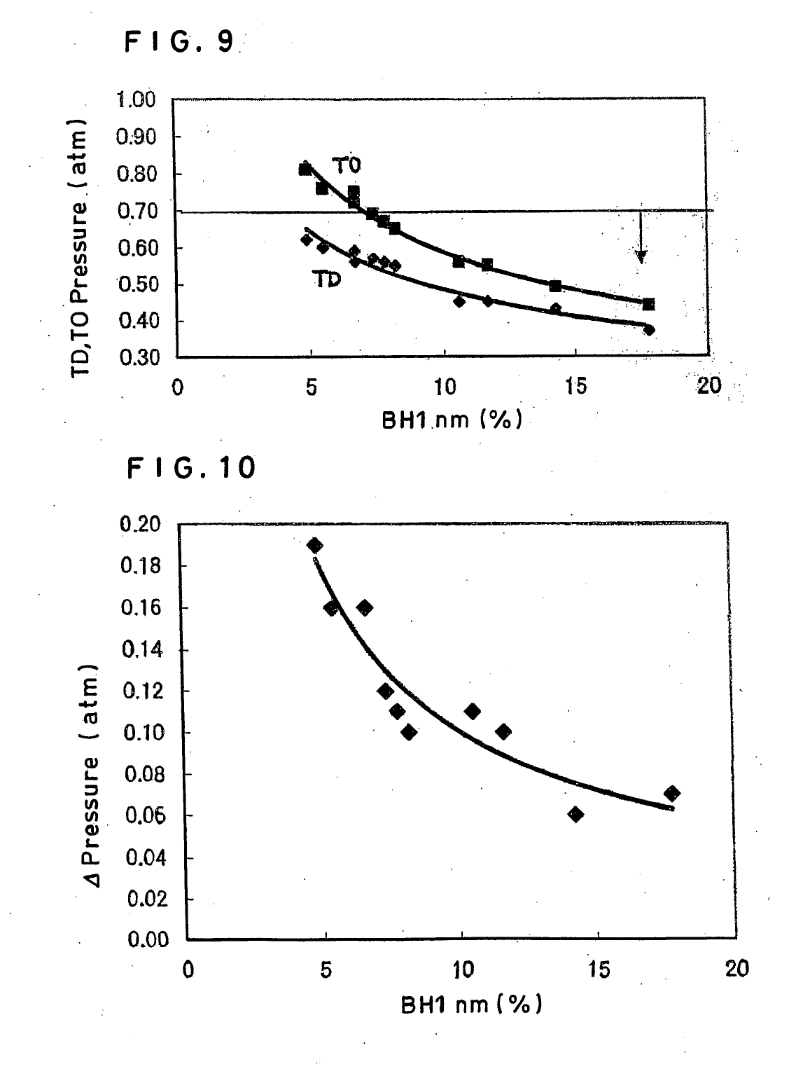

FIG. 9 shows the data of the TD-TO test performed in the presence of the texturing process. In this case, in order that the TO pressure inclusive of possible dispersion of data may be set at 0.7 atm. or less, i.e. more rigidly than in the case of the absence of the texturing process, the “BH 1.0 nm” is required to be 7% or more. It is also noted from FIG. 10 that the Δ pressure C suddenly increases, namely the ability to induce adhesion is exalted.

The preceding results of the test indicate that by setting “BH 1.0 nm” as the surface roughness of the magnetic disk at a level of 5% or more, particularly at a level of 7% or more in the presence of the texturing process, it is made possible to secure the stability of the floatation of the magnetic head under the atmosphere of a reduced pressure of 0.76 atm. even when the amount of floatation of the magnetic head is as low as 10.0 nm or less.

Then, the following load-unload test was performed with the object of determining the presence or absence of the pickup of a lubricant material by the magnetic head which is suspended to occur when the surface roughness of the magnetic disk is large. Similarly to the preceding test, a plurality of magnetic disks having different magnitudes of “BH 1.0 nm” and a uniform size of 1.0 inch (25.4 mm size) were prepared. Each of the magnetic disks was set in a magnetic disk device rotating at 10000 rpm and the operation of loading and unloading the magnetic head inside and outside the plane of the magnetic disk was repeated. The environment of the test was kept at a temperature of 70° C. and a humidity of 80% RH. The loading-unloading operation was carried out to 500,000 repetitions. Thereafter, the magnetic disk device was disassembled and tested for the presence or absence of the adhesion of the lubricant material to the magnetic head.

The results of the loading-unloading test are shown in Tables 1 and 2 below.

TABLE 1

| | | | | | | | | | | | | Pickup |
|---|---|---|---|---|---|---|---|---|---|---|---|---|
| | | | | | | | | BH | | | | of |
| | Alkali | Conc. | Surfactant | Conc. | Temp. | Time | Ra | 1.0 nm | TD | TO | Δ | lubricant |
| | component | wt % | component | wt % | (° C.) | (min) | (Å) | (%) | pressure | pressure | pressure | material |
| Ex. 1 | Potassium | 10 | ANSS | 1 | 50 | 1 | 3.1 | 6.1 | 0.50 | 0.65 | 0.15 | Absence |
| | hydroxide | | | | | | | | | | | |
| Ex. 2 | Potassium | 25 | ″ | 1 | 50 | 1 | 3.7 | 8.5 | 0.49 | 0.62 | 0.13 | Absence |
| | hydroxide | | | | | | | | | | | |
| Ex. 3 | Potassium | 50 | ″ | 1 | 50 | 1 | 4.7 | 13.5 | 0.39 | 0.46 | 0.07 | Absence |
| | hydroxide | | | | | | | | | | | |
| Ex. 4 | Potassium | 25 | ″ | 0.5 | 50 | 1 | 3.8 | 8.9 | 0.48 | 0.57 | 0.09 | Absence |
| | hydroxide | | | | | | | | | | | |
| Ex. 5 | Potassium | 25 | ″ | 2 | 50 | 1 | 3.9 | 9.1 | 0.47 | 0.56 | 0.09 | Absence |
| | hydroxide | | | | | | | | | | | |
| Ex. 6 | Potassium | 25 | ″ | 1 | 25 | 1 | 3.2 | 5.9 | 0.56 | 0.68 | 0.12 | Absence |
| | hydroxide | | | | | | | | | | | |
| Ex. 7 | Potassium | 25 | ″ | 1 | 75 | 1 | 6.2 | 15.1 | 0.37 | 0.43 | 0.06 | Absence |
| | hydroxide | | | | | | | | | | | |
| Ex. 8 | Potassium | 25 | ″ | 1 | 50 | 2 | 3.8 | 7.1 | 0.55 | 0.67 | 0.12 | Absence |
| | hydroxide | | | | | | | | | | | |
| Ex. 9 | Potassium | 25 | ″ | 1 | 50 | 5 | 5.2 | 8.2 | 0.47 | 0.57 | 0.10 | Absence |
| | hydroxide | | | | | | | | | | | |
| Ex. 10 | Potassium | 25 | ″ | 1 | 50 | 10 | 6.5 | 11.6 | 0.42 | 0.52 | 0.10 | Absence |
| | hydroxide | | | | | | | | | | | |
| Ex. 11 | Potassium | 25 | ADPESDS | 1 | 50 | 1 | 4.1 | 6.7 | 0.45 | 0.55 | 0.10 | Absence |
| | hydroxide | | | | | | | | | | | |
| Ex. 12 | Potassium | 25 | APP | 1 | 50 | 1 | 3.9 | 7.2 | 0.52 | 0.63 | 0.11 | Absence |
| | hydroxide | | | | | | | | | | | |
| Ex. 13 | Potassium | 25 | LTMAC | 1 | 50 | 1 | 4.5 | 6.9 | 0.55 | 0.68 | 0.13 | Absence |
| | hydroxide | | | | | | | | | | | |
| Ex. 14 | Potassium | 25 | STMAC | 1 | 50 | 1 | 5.1 | 7.6 | 0.45 | 0.54 | 0.09 | Absence |
| | hydroxide | | | | | | | | | | | |
| Ex. 15 | Potassium | 25 | SAA | 1 | 50 | 1 | 3.9 | 6.4 | 0.54 | 0.65 | 0.11 | Absence |
| | hydroxide | | | | | | | | | | | |
| Ex. 16 | Potassium | 25 | LB | 1 | 50 | 1 | 4.5 | 7.3 | 0.52 | 0.61 | 0.09 | Absence |
| | hydroxide | | | | | | | | | | | |
| Ex. 17 | Potassium | 25 | SB | 1 | 50 | 1 | 4.3 | 6.4 | 0.49 | 0.61 | 0.12 | Absence |
| | hydroxide | | | | | | | | | | | |
| Ex. 18 | Potassium | 25 | LDMAO | 1 | 50 | 1 | 5.2 | 5.9 | 0.52 | 0.63 | 0.11 | Absence |
| | hydroxide | | | | | | | | | | | |
| Ex. 19 | Potassium | 25 | ANSS | 1 | 50 | 1 | 5.3 | 6.7 | 0.49 | 0.59 | 0.10 | Absence |
| | hydroxide | | | | | | | | | | | |
| Comp. | None | | None | | | | 2.3 | 2.7 | 0.65 | 0.96 | 0.31 | Absence |
| Ex. 1 | | | | | | | | | | | | |
| Comp. | Potassium | 0.5 | ANSS | 1 | 50 | 1 | 2.7 | 3.1 | 0.67 | 0.91 | 0.24 | Absence |
| Ex. 2 | hydroxide | | | | | | | | | | | |
| Comp. | Potassium | 25 | None | | 50 | 1 | 15.7 | 25.3 | 0.38 | 0.41 | 0.03 | Presence |
| Ex. 3 | hydroxide | | | | | | | | | | | |
| Comp. | Potassium | 80 | ANNS | 1 | 50 | 1 | 17.2 | 27.9 | 0.35 | 0.42 | 0.07 | Presence |
| Ex. 4 | hydroxide | | | | | | | | | | | |
| Comp. | Potassium | 25 | ANNS | 1 | 90 | 1 | 12.8 | 22.6 | 0.39 | 0.44 | 0.05 | Presence |
| Ex. 5 | hydroxide | | | | | | | | | | | |

ANSS: Alkyl naphthalene sodium sulphonate
ADPESDS: Alkyl diphenyl ether sodium disulphonate
APP: Alkyl potassium phosphate
LTMAC: Lauryl trimethyl ammonium chloride
STMAC: Stearyl trimethyl ammonium chloride
SAA: Stearyl amine acetate
LB: Lauryl betaine
SB: Stearyl betaine
LDMAO: Lauryl dimethyl amine oxide

TABLE 2

| | | | | | | | | BH | | | | Pickup of |
|---|---|---|---|---|---|---|---|---|---|---|---|---|
| | Alkali | Conc. | Surfactant | Conc. | Temp. | Time | Ra | 1.0 nm | TD | TO | Δ | Lubricant |
| | component | wt % | component | wt % | (° C.) | (min) | (Å) | (%) | pressure | pressure | pressure | material |
| Ex. | Potassium | 10 | ANSS | 1 | 50 | 1 | 2.9 | 5.5 | 0.60 | 0.76 | 0.16 | Absence |
| 20 | hydroxide | | | | | | | | | | | |
| Ex. | Potassium | 25 | ANSS | 1 | 50 | 1 | 3.5 | 7.8 | 0.56 | 0.67 | 0.11 | Absence |
| 21 | hydroxide | | | | | | | | | | | |
| Ex. | Potassium | 50 | ANSS | 1 | 50 | 1 | 4.5 | 11.7 | 0.45 | 0.55 | 0.10 | Absence |
| 22 | hydroxide | | | | | | | | | | | |
| Ex. | Potassium | 25 | ANSS | 0.5 | 50 | 1 | 3.5 | 7.4 | 0.57 | 0.68 | 0.12 | Absence |
| 23 | hydroxide | | | | | | | | | | | |
| Ex. | Potassium | 25 | ANSS | 2 | 50 | 1 | 3.5 | 8.2 | 0.55 | 0.654 | 0.10 | Absence |
| 24 | hydroxide | | | | | | | | | | | |
| Ex. | Potassium | 25 | ANSS | 1 | 25 | 1 | 2.9 | 4.9 | 0.62 | 0.81 | 0.19 | Absence |
| 25 | hydroxide | | | | | | | | | | | |
| Ex. | Potassium | 25 | ANSS | 1 | 75 | 1 | 6.2 | 14.3 | 0.43 | 0.49 | 0.06 | Absence |
| 26 | hydroxide | | | | | | | | | | | |
| Ex. | Potassium | 25 | ANSS | 1 | 50 | 2 | 3.7 | 6.7 | 0.59 | 0.75 | 0.16 | Absence |
| 27 | hydroxide | | | | | | | | | | | |
| Ex. | Potassium | 25 | ANSS | 1 | 50 | 5 | 4.7 | 6.7 | 0.56 | 0.72 | 0.16 | Absence |
| 28 | hydroxide | | | | | | | | | | | |
| Ex. | Potassium | 25 | ANSS | 1 | 50 | 10 | 5.9 | 10.6 | 0.45 | 0.56 | 0.11 | Absence |
| 29 | hydroxide | | | | | | | | | | | |
| Ex. | Potassium | 50 | ANSS | 1 | 50 | 10 | 5.9 | 17.8 | 0.37 | 0.44 | 0.07 | Presence |
| 30 | hydroxide | | | | | | | | | | | |

ANSS: Alkyl naphthalene sodium sulphonate

As noted from these tables, in the absence of the texturing process, the pickup of the lubricant material was observed when the “BH 1.0 nm” was larger than 20%. The phenomenon of the pickup of the lubricant material is thought to occur proportionately to the frequency of contact between the magnetic head and the magnetic disk. The fact that the pickup of the lubricant material occurs may well be regarded as supporting an inference that the magnetic head is liable to be fractured by the thermal asperity and the electrostatic breakdown. When the “BH 1.0 nm” is greater than 20%, the overage will result in coarsening the magnetic disk surface and consequently rendering it difficult to decrease the spacing between the magnetic head and the magnetic disk. As a result, the target of high densification of recording is not easily attained and the reliability of the magnetic disk and the magnetic disk device is not secured.

### INDUSTRIAL APPLICABILITY

It is plain from the foregoing results that by controlling the surface roughness of the magnetic disk, thereby restricting the value of “BH 1.0 nm” in the range from 5% through 20%, it is made possible to keep the electromagnetic transfer characteristic of the magnetic disk intact and secure the high densification of recording and the stability of floatation of the magnetic head. Particularly, when the magnetic disk substrate has undergone the texturing process, the surface roughness of the magnetic disk is preferably controlled so as to restrict the value of “BH 1.0 nm” in the range of 7% to 15%.

Incidentally, this invention does not need to be restricted faithfully to the preceding embodiment but may be embodied in the stage of practice by modifying the component elements thereof without departure from the spirit of the invention. Further, various invention may be derived by suitably combining the plurality of component elements disclosed in the preceding embodiment. It is permissible, for example, to exclude a few component elements from all the component elements disclosed in the present embodiment. It is also permissible to combine suitably component elements which are covered by different embodiments.

In the magnetic disk, for example, the materials and the film thicknesses of the base film, recording film, intermediate film, lubricant, etc. do not need to be restricted to those specified in the preceding embodiment but may be variously selected to suit the need. Further, in the magnetic disk device, the number of magnetic disks may be increased or decreased as occasion demands.

1. A method for the production of a substrate for a magnetic recording medium, comprising subjecting a silicon substrate to a chemical etching treatment using an etchant containing an aqueous alkali solution and a surfactant.

2. A method according to claim 1, wherein the chemical etching treatment imparts irregularities to a surface of the substrate.

3. A method according to claim 1, wherein the aqueous alkali solution contains potassium hydroxide or sodium hydroxide and the etchant has a concentration of an alkali component in a range of 1 mass % to 60 mass %.

4. A method according to claim 1, wherein the surfactant is an anionic surfactant and the etchant has a concentration of an anionic surfactant component in a range of 0.1 mass % to 5 mass %.

5. A method according to claim 4, wherein the anionic surfactant is at least one member selected from the group consisting of alkyl naphthalene sodium sulfonates, alkyl diphenyl ether sodium disulfonates and alkyl potassium phosphates.

6. A method according to claim 5, wherein the surfactant is a cationic surfactant and the etchant has a concentration of a cationic surfactant component in a range of 0.1 mass % to 5 mass %.

7. A method according to claim 6, wherein the cationic surfactant is at least one member selected from the group consisting of lauryl trimethyl ammonium chloride, stearyl trimethyl ammonium chloride and stearyl amine acetate.

8. A method according to claim 7, wherein the surfactant is an amphoteric surfactant and the etchant has a concentration of an amphoteric surfactant component in a range of 0.1 mass % to 5 mass %.

9. A method according to claim 8, wherein the amphoteric surfactant is at least one member selected from the group consisting of lauryl betaine, stearyl betaine and lauryl dimethyl amine oxide.

10. A method according to claim 1, wherein the etchant has a liquid temperature in a range of 20° C. to 80° C.

11. A method according to claim 1, wherein the silicon substrate has surface irregularities having a value of contact ratio (BH 1.0 nm) of 5% or more and 20% or less in a region of a height of 1.0 nm or more, based on a height at which the contact ratio reaches 50% in a surface coarseness load curve.

12. A method according to claim 1, wherein the silicon substrate is made of single crystal silicon.

13. A method according to claim 1, wherein the silicon substrate is made of polycrystalline silicon.

14. A method according to claim 1, wherein the substrate has a diameter of 50 mm or less.

15. A substrate for a magnetic recording medium, which is provided on a surface thereof with irregularities possessing a value of contact ratio (BH 1.0 nm) of 5% or more and 20% or less in a region of a height of 1.0 nm or more, based on a height at which the contact ratio reaches 50% in a surface coarseness load curve.

16. A substrate according to claim 15, wherein the silicon substrate is made of single crystal silicon.

17. A substrate according to claim 15, wherein the silicon substrate is made of polycrystalline silicon.

18. A substrate according to claim 15, wherein the substrate has a diameter of 50 mm or less.

19. A substrate for a magnetic recording medium, produced using the method for the production of a substrate for a magnetic recording medium according to claim 1.

20. A magnetic recording medium furnished on the substrate for a magnetic recording medium according to claim 15 with a magnetic film, a protective film and a lubricant layer, which magnetic recording medium is furnished on a surface thereof with irregularities having a value of contact ratio (BH 1.0 nm) of 5% or more and 20% or less in a region of a height of 1.0 nm or more, based on a height at which the contact ratio reaches 50% in a surface coarseness load curve.

21. A magnetic recording medium furnished on a substrate for a magnetic recording medium using a silicon substrate with a magnetic film, a protective film and a lubricant layer, which magnetic recording medium is furnished on a surface thereof with irregularities having a value of contact ratio (BH 1.0 nm) of 5% or more and 20% or less in a region of a height of 1.0 nm or more, based on a height at which the contact ratio reaches 50% in a surface coarseness load curve.

22. A magnetic recording and reproducing device that is provided with the magnetic recording medium according to claim 20 and a magnetic head adapted to record and reproduce data in the magnetic recording medium.
